(19) United States
(12) Patent Application Publication
(10) Pub. No.: US 2026/0037290 A1
(43) Pub. Date: Feb. 5, 2026

(54) MACHINE INTERPRETATION FOR A VIRTUALIZED GUEST CONFIGURATION

(71) Applicant: INTERNATIONAL BUSINESS MACHINES CORPORATION, Armonk, NY (US)

(72) Inventors: Janosch Andreas FRANK, Stuttgart (DE); Lisa Cranton HELLER, Rhinebeck, NY (US); Christian BORNTRAEGER, Stuttgart (DE); Fadi Y. BUSABA, Poughkeepsie, NY (US)

(21) Appl. No.: 18/790,807

(22) Filed: Jul. 31, 2024

(51) Int. Cl. G06F 9/455

(52) U.S. Cl. CPC G06F 9/45558; G06F 2009/45566

(57) ABSTRACT

Interpretative execution is performed by a physical processor of a computing environment for a virtual processor executing on the physical processor. The performing interpretative execution includes obtaining an order code indicating an action to be taken for the virtual processor and accessing a shadow state description of the virtual processor to obtain an original state description origin. The original state description origin indicates the location of an original state description of the virtual processor, and the original state description includes state information of the virtual processor. An action is performed using an indicator of the state information of the virtual processor. The indicator is selected based on the order code, and the action is performed by the physical processor on behalf of the virtual processor.

### BACKGROUND

One or more aspects relate, in general, to facilitating processing within a computing environment, and in particular, to improving processing within a virtualized computing environment.

In selected virtualized computing environments, computer hardware and firmware provide accelerated support for a select number of levels of running guests (e.g., hypervisors, operating systems). For example, the computer hardware and firmware provide accelerated support for two levels of running guests, in which a first level guest may be a hypervisor, sometimes referred to as guest 1, and the second level guest is, for instance, an operating system dispatched by guest 1.

If additional levels of virtualization are to be provided, then those additional levels are provided by software. For example, the second level guest would also be a hypervisor that dispatches a third level guest. However, since the additional levels are provided by software, the accelerated support provided by the computer hardware and firmware is unavailable.

### SUMMARY

Shortcomings of the prior art are overcome, and additional advantages are provided through the provision of a computer program product. The computer program product includes a set of one or more computer-readable storage media and program instructions, collectively stored in the set of one or more computer-readable storage media, for causing at least one computing device to perform computer operations including performing interpretative execution by a physical processor of a computing environment for a virtual processor executing on the physical processor. The performing interpretative execution includes obtaining an order code indicating an action to be taken for the virtual processor and accessing a shadow state description of the virtual processor to obtain an original state description origin. The original state description origin indicates a location of an original state description of the virtual processor, and the original state description includes state information of the virtual processor. An action is performed using an indicator of the state information of the virtual processor. The indicator is selected based on the order code, and the action is performed by the physical processor on behalf of the virtual processor.

In one or more aspects, a computer program product is provided that includes a set of one or more computer-readable storage media and program instructions, collectively stored in the set of one or more computer-readable storage media, for causing at least one computing device to perform computer operations including performing interpretative execution by a physical processor of a computing environment for a virtual processor executing on the physical processor. The performing interpretative execution includes accessing a shadow control structure of the virtual processor to obtain addressability to an original control structure of the virtual processor. The original control structure includes state information of the virtual processor. An action is performed using the state information of the virtual processor. The action is performed by the physical processor on behalf of the virtual processor.

Computer program products, computer systems and computer-implemented methods relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present disclosure;

FIG. 2 depicts one example of further details of a processor of the processor set of FIG. 1, in accordance with one or more aspects of the present disclosure;

FIG. 3 depicts one example of a sender processor to provide order codes for a target processor, in accordance with one or more aspects of the present disclosure;

FIG. 4A depicts one example of a nested guest executing within a computing environment, in accordance with one or more aspects of the present disclosure;

FIG. 4B depicts one example of a nested guest (e.g., a guest level 3 guest) being run as a different level guest (e.g., a guest 2 level guest), in accordance with one or more aspects of the present disclosure;

FIG. 5 depicts one example of a system control area used in accordance with one or more aspects of the present disclosure;

FIG. 6A depicts one example of an original state description used in accordance with one or more aspects of the present disclosure;

FIG. 6B depicts one example of a shadow state description used in accordance with one or more aspects of the present disclosure;

FIG. 7 depicts one example of a shadow state description that includes an original state description origin, in accordance with one or more aspects of the present disclosure;

FIG. 8A depicts one example of a shadow system control area, in accordance with one or more aspects of the present disclosure;

FIG. 8B depicts one example of using a shadow system control area, in accordance with one or more aspects of the present disclosure;

FIG. 9 depicts one example of the signal processor interpretation code of FIG. 1, in accordance with one or more aspects of the present disclosure;

FIG. 10A depicts one example of signal processor interpretation processing, in accordance with one or more aspects of the present disclosure;

FIG. 10B depicts one example of interpretative execution of an action for a sense running status order code, in accordance with one or more aspects of the present disclosure;

FIGS. 10C-10D depict one example of interpretative execution of one or more actions for an external call order code, in accordance with one or more aspects of the present disclosure; and

FIGS. 11A-11B depict another example of a computing environment to incorporate and use one or more aspects of the present disclosure.

### DETAILED DESCRIPTION

In accordance with one or more aspects of the present disclosure, a capability is provided to facilitate processing within a computing environment. In one or more aspects, machine interpretation for a virtualized guest configuration is provided. This includes providing hardware-assisted (e.g., hardware/firmware) interpretative execution for guests that previously were unable to benefit from hardware-assisted interpretative execution. Such guests are referred to as nested guests. By providing hardware-assisted interpretative execution for nested guests, system performance is improved, and latency is reduced.

In one or more aspects, hardware-assisted interpretation for nested guests is facilitated by providing to a guest on a selected level (e.g., a guest 1 level guest or other level guest) accessibility to context of a guest on another level (e.g., a guest level 2 guest or another level guest). That context was previously inaccessible to the guest on the selected level. However, in accordance with one or more aspects, accessibility to the context is provided to the guest on the selected level and to the physical processor. The context is included in a control structure of the guest on the other level, referred to as an original control structure. This original control structure is directly inaccessible to the guest on the selected level. Therefore, in one or more aspects, addressability to that context and to the original control structure is included in another control structure of the guest on the other level, referred to as a shadow control structure. The shadow control structure is accessible to the guest on the selected level and to the physical processor.

In one example, machine interpretation for a virtualized guest environment includes signal processor (SIGP)) machine interpretation. However, it may be used for other machine interpretation processing. Signal processor machine interpretation is only one example.

In one or more aspects, a computer program product is provided that includes a set of one or more computer-readable storage media and program instructions, collectively stored in the set of one or more computer-readable storage media, for causing at least one computing device to perform computer operations including performing interpretative execution by a physical processor of a computing environment for a virtual processor executing on the physical processor. The performing interpretative execution includes accessing a shadow control structure of the virtual processor to obtain addressability to an original control structure of the virtual processor. The original control structure includes state information of the virtual processor. An action is performed using the state information of the virtual processor. The action is performed by the physical processor on behalf of the virtual processor. Virtual processor execution is improved by enabling hardware-assisted support.

Additionally, or alternatively, the shadow control structure is a control structure selected from set of control structures. The set of control structures includes a shadow state description of the virtual processor and a shadow system control area of the virtual processor. The original control structure is another control structure selected from another set of control structures. The another set of control structures includes an original state description of the virtual processor and an original system control area of the virtual processor. Use of these control structures facilitates access to the virtual processor's context, improving performance.

In accordance with one or more aspects, each of the embodiments is separable and optional from one another. Further, embodiments may be combined with one another.

In one or more aspects, a computer-implemented method is provided that includes performing interpretative execution by a physical processor of a computing environment for a virtual processor executing on the physical processor. The performing interpretative execution includes accessing a shadow control structure of the virtual processor to obtain addressability to an original control structure of the virtual processor. The original control structure includes state information of the virtual processor. An action is performed using the state information of the virtual processor. The action is performed by the physical processor on behalf of the virtual processor. Virtual processor execution is improved by enabling hardware-assisted support.

In accordance with one or more aspects, each of the embodiments is separable and optional from one another. Further, embodiments may be combined with one another.

In one or more aspects, a computer program product is provided. The computer program product includes a set of one or more computer-readable storage media, and program instructions, collectively stored in the set of one or more computer-readable storage media, for causing at least one computing device to perform computer operations including performing interpretative execution by a physical processor of a computing environment for a virtual processor executing on the physical processor. The performing interpretative execution includes obtaining an order code indicating an action to be taken for the virtual processor and accessing a shadow state description of the virtual processor to obtain an original state description origin. The original state description origin indicates a location of an original state description of the virtual processor. The original state description includes state information of the virtual processor. An action is performed using an indicator of the state information of the virtual processor. The indicator is selected based on the order code, and the action is performed by the physical processor on behalf of the virtual processor. Virtual processor execution is improved by enabling hardware-assisted support for processing the order code. This increases system performance and reduces latency.

Additionally, or alternatively, in one or more embodiments, accessing the shadow state description includes accessing a shadow signal processor entry of a shadow system control area to obtain a shadow state description address of the shadow state description. Use of the shadow system control area facilitates access to the shadow state description, improving performance.

Additionally, or alternatively, in one or more embodiments, the shadow signal processor entry further includes an original signal processor entry address of an original signal processor entry of an original system control area of the virtual processor. This facilitates access to the original signal processor entry of the original system control area, in addition to the shadow system control area.

Additionally, or alternatively, in one or more embodiments, the original signal processor entry and the shadow signal processor entry include information for the virtual processor, and selected information is accessible from the original signal processor entry rather than the shadow signal processor entry. This facilitates access to the selected information of the virtual processor, which enables interpretative execution. This improves system performance.

Additionally, or alternatively, in one or more embodiments, the order code includes obtaining a sense running status of the virtual processor that specifies whether the virtual processor is running. This facilitates processing within the computing environment.

Additionally, or alternatively, in one or more embodiments, the order code includes an external call external interruption. This facilitates interpretive execution of external call interruptions, improving system performance.

Additionally, or alternatively, in one or more embodiments, the virtual processor is a nested virtual processor. Providing interpretative execution for nested virtual processors improves performance and reduces latency.

Additionally, or alternatively, in one or more embodiments, the virtual processor is initiated via a start interpretative execution instruction. The start interpretative execution instruction includes an operand that specifies a location of the original state description of the virtual processor. This enables interpretative execution, which improves system performance when running guests.

Additionally, or alternatively, in one or more embodiments, the original state description of the virtual processor is accessible to the physical processor via the shadow state description and directly inaccessible to the physical processor. By accessing the original state description via the shadow state description, the physical processor has access to both state descriptions enabling hardware-assisted support for interpretative execution.

Additionally, or alternatively, in one or more embodiments, the obtaining the order code includes obtaining the order code based on execution of a signal processor instruction by another virtual processor. The signal processor instruction specifies the order code and the virtual processor. This facilitates interpretative execution of the order code.

In accordance with one or more aspects, each of the embodiments is separable and optional from one another. Further, embodiments may be combined with one another.

In one or more aspects, a computer system is provided. The computer system includes at least one computing device, a set of one or more computer-readable storage media, and program instructions, collectively stored in the set of one or more computer-readable storage media, for causing the at least one computing device to perform computer operations including performing interpretative execution by a physical processor of a computing environment for a virtual processor executing on the physical processor. The performing interpretative execution includes obtaining an order code indicating an action to be taken for the virtual processor and accessing a shadow state description of the virtual processor to obtain an original state description origin. The original state description origin indicates a location of an original state description of the virtual processor. The original state description includes state information of the virtual processor. An action is performed using an indicator of the state information of the virtual processor. The indicator is selected based on the order code, and the action is performed by the physical processor on behalf of the virtual processor. Virtual processor execution is improved by enabling hardware-assisted support for processing the order code. This increases system performance and reduces latency.

Additionally, or alternatively, in one or more embodiments, accessing the shadow state description includes accessing a shadow signal processor entry of a shadow system control area to obtain a shadow state description address of the shadow state description. The shadow signal processor entry further includes an original signal processor entry address of an original signal processor entry of an original system control area of the virtual processor. This facilitates access to the original signal processor entry of the original system control area, in addition to the shadow system control area. Use of the shadow system control area facilitates access to the shadow state description, improving performance.

Additionally, or alternatively, in one or more embodiments, the original signal processor entry and the shadow signal processor entry include information for the virtual processor, and selected information is accessible from the original signal processor entry rather than the shadow signal processor entry. This facilitates access to the selected information of the virtual processor, which enables interpretative execution. This improves system performance.

Additionally, or alternatively, in one or more embodiments, the order code includes obtaining a sense running status of the virtual processor that specifies whether the virtual processor is running. This facilitates processing within the computing environment.

Additionally, or alternatively, in one or more embodiments, the order code includes an external call external interruption. This facilitates interpretive execution of external call interruptions, improving system performance.

Additionally, or alternatively, in one or more embodiments, the virtual processor is a nested virtual processor. Providing interpretative execution for nested virtual processors improves performance and reduces latency.

In accordance with one or more aspects, each of the embodiments is separable and optional from one another. Further, embodiments may be combined with one another.

In one or more aspects, a computer-implemented method is provided. The computer-implemented method includes performing interpretative execution by a physical processor of a computing environment for a virtual processor executing on the physical processor. The performing interpretative execution includes obtaining an order code indicating an action to be taken for the virtual processor and accessing a shadow state description of the virtual processor to obtain an original state description origin. The original state description origin indicates a location of an original state description of the virtual processor. The original state description includes state information of the virtual processor. An action is performed using an indicator of the state information of the virtual processor. The indicator is selected based on the order code, and the action is performed by the physical processor on behalf of the virtual processor. Virtual processor execution is improved by enabling hardware-assisted support for processing the order code. This increases system performance and reduces latency.

Additionally, or alternatively, in one or more embodiments, accessing the shadow state description includes accessing a shadow signal processor entry of a shadow system control area to obtain a shadow state description address of the shadow state description. The shadow signal processor entry further includes an original signal processor entry address of an original signal processor entry of an original system control area of the virtual processor. This facilitates access to the original signal processor entry of the original system control area, in addition to the shadow system control area. Use of the shadow system control area facilitates access to the shadow state description, improving performance.

Additionally, or alternatively, in one or more embodiments, the original signal processor entry and the shadow signal processor entry include information for the virtual processor, and selected information is accessible from the original signal processor entry rather than the shadow signal processor entry. This facilitates access to the selected information of the virtual processor, which enables interpretative execution. This improves system performance.

Additionally, or alternatively, in one or more embodiments, the order code includes obtaining a sense running status of the virtual processor that specifies whether the virtual processor is running. This facilitates processing within the computing environment.

Additionally, or alternatively, in one or more embodiments, the order code includes an external call external interruption. This facilitates interpretive execution of external call interruptions, improving system performance.

Additionally, or alternatively, in one or more embodiments, the virtual processor is a nested virtual processor. Providing interpretative execution for nested virtual processors improves performance and reduces latency.

In accordance with one or more aspects, each of the embodiments is separable and optional from one another. Further, embodiments may be combined with one another.

In one or more aspects, a computer program product, computer system and/or computer-implemented method may be provided in which an order code is transmitted from a sender virtual processor of a computing environment to a target virtual processor of the computing environment. The order code indicates an action to be taken for the target virtual processor. A shadow state description of the target virtual processor is accessed to obtain an original state description origin. The original state description origin indicates a location of an original state description of the target virtual processor. The original state description includes state information of the target virtual processor. An action is performed using an indicator of the state information of the target virtual processor. The indicator is selected based on the order code, and the action is performed using interpretative execution by a physical processor executing the sender virtual processor. Virtual processor execution is improved by enabling hardware-assisted support for processing the order code. This increases system performance and reduces latency.

In accordance with one or more aspects, each of the embodiments is separable and optional from one another. Further, embodiments may be combined with one another.

In one or more aspects, a computer program product, computer system and/or computer-implemented method may be provided in which a target virtual processor of a computing environment receives from a sender virtual processor of the computing environment an order code indicating an action to be taken by the target virtual processor. A shadow state description of the target virtual processor is accessed to obtain an original state description origin. The original state description origin indicates a location of an original state description of the target virtual processor. The original state description includes state information of the target virtual processor. An action is performed using an indicator of the state information of the target virtual processor. The indicator is selected based on the order code, and the action is performed using interpretative execution by a physical processor executing the target virtual processor. Virtual processor execution is improved by enabling hardware-assisted support for processing the order code. This increases system performance and reduces latency.

In accordance with one or more aspects, each of the embodiments is separable and optional from one another. Further, embodiments may be combined with one another.

Computer program products, computer systems and computer-implemented methods relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that, e.g., performs machine interpretation processing (including, but not limited to, signal processor machine interpretation processing), e.g., for a virtualized guest environment and/or one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

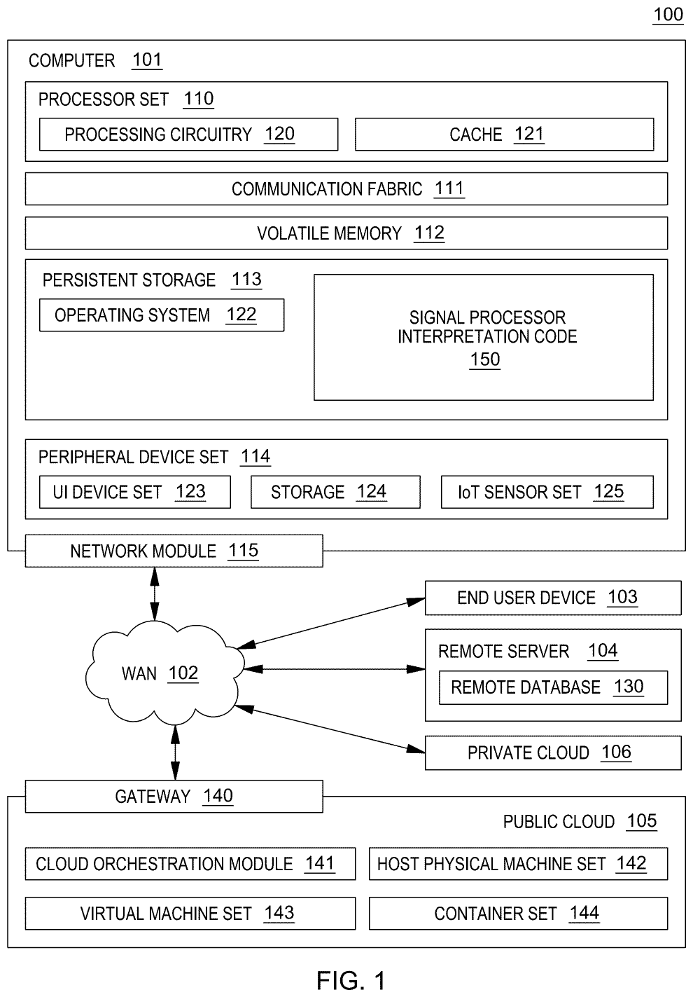

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as signal processor interpretation code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

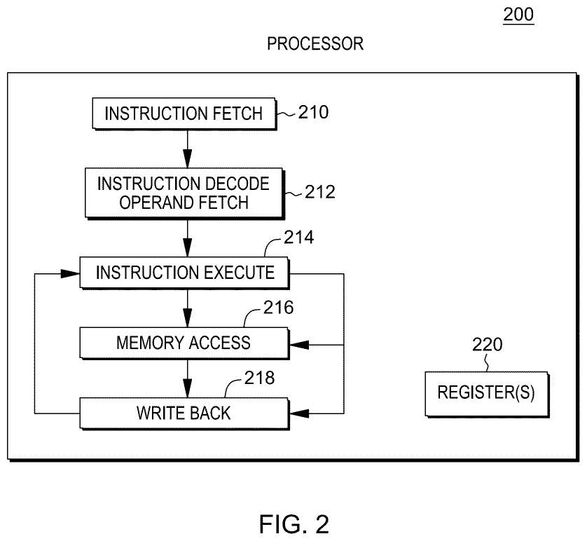

In one example, a processor (e.g., of processor set 110) includes a plurality of functional components (or a subset thereof) used to execute instructions. As depicted in FIG. 2, in one example, a processor 200 includes, for instance, an instruction fetch component 210 to fetch instructions to be executed; an instruction decode/operand fetch component 212 to decode the fetched instructions and to obtain operands of the decoded instructions; one or more instruction execute components 214 to execute the decoded instructions; a memory access component 216 to access memory for instruction execution, if necessary; and a write back component 218 to provide the results of the executed instructions. One or more of the components may access and/or use one or more registers 220 in instruction processing. Further, one or more of the components may access and/or use signal processor interpretation code 150. Additional, fewer and/or other components may be used in one or more aspects of the present disclosure.

An instruction that may be executed, in accordance with one or more aspects of the present disclosure, is a signal processor (SIGP) instruction and/or a start interpretive execution (SIE) instruction, each of which is part of an instruction set architecture. One example of an instruction set architecture to incorporate and/or use the signal processor instruction, the start interpretive execution instruction, other instructions, signal processor interpretation processing and/or machine interpretation for a virtualized environment is the z/Architecture© instruction set architecture offered by International Business Machines Corporation, Armonk, New York. One embodiment of the z/Architecture instruction set architecture is described in a publication entitled, “z/Architecture Principles of Operation,” IBM Publication No. SA22-7832-13, Fourteenth Edition, May 2022, which is hereby incorporated herein by reference in its entirety. The z/Architecture instruction set architecture, however, is only one example architecture; other architectures and/or other types of computing environments of International Business Machines Corporation and/or of other entities/companies may include and/or use one or more aspects of the present disclosure. z/Architecture and IBM are trademarks or registered trademarks of International Business Machines Corporation in at least one jurisdiction.

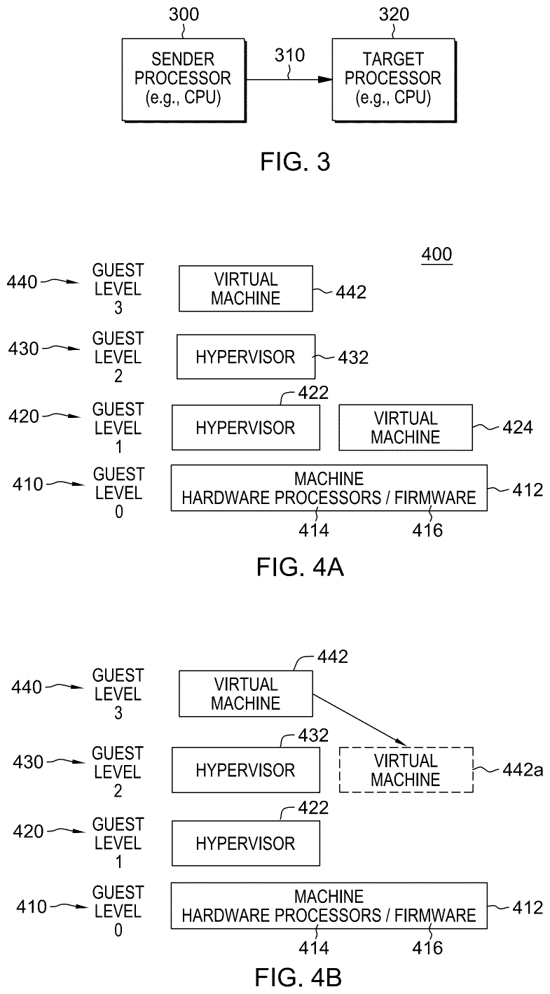

In one example, a signal processor instruction is used by a sender processor to provide (e.g., transmit, indicate) orders (e.g., order codes) for a target processor and to perform one or more actions on the sender processor and/or the target processor. For instance, referring to FIG. 3, a sender processor (e.g., central processing unit (CPU)) 300 executes a signal processor instruction (e.g., a Signal Processor (SIGP) instruction) to provide 310 an order code for a target processor (e.g., CPU) 320. As examples, the providing the order code includes transmitting the order code to the target processor (e.g., for an external interrupt) or taking action on behalf of the target processor (e.g., obtaining status of the target processor). The Signal Processor instruction is used, as examples, to obtain a target processor's running status (e.g., is processor actively running, etc.); cause an external interrupt; reset the target processor (e.g., instruct the target processor to reset); store the target processor's state; and/or set the target processor's mode, as examples. Other examples are possible.

Execution of a Signal Processor instruction on a sender processor (e.g., processor 300) includes, for instance, providing, at least, an order code (e.g., 8-bit order code) for a target processor (e.g., processor 320) designated by a processor (e.g., CPU) address contained in a third operand of the instruction (e.g., R₃; i.e., a general register specified in R₃). The result is indicated by a condition code and may be detailed by status assembled in selected bit positions (e.g., bit positions 32-63) of the first operand location of the instruction (e.g., R₁; i.e., a general register specified in R₁). In one example, selected bits (e.g., bits 56-63) of a second operand address contain the order code. In one example, bits in a general register R₂ concatenated with the bits in D₂ form the second operand address. Other examples are possible.

Example order codes include an order code specifying an external call (e.g., code 2) and an order code specifying sense running status (e.g., 21). Additional, fewer and/or other order codes may be specified. External call and sense running status are just examples of two order codes to be discussed herein. Again, other examples are possible.

In one example, the external call (interrupt) and the retrieving the sense running status are used by a control program (e.g., operating system) executing on the sender processor. Often, they are used to schedule work. At times, a hypervisor performs the actions specified in the definition of the instruction. In such situations, the hypervisor emulates execution of the instruction and the actions defined therein. However, to reduce hypervisor emulation and latency for selected order codes, such as SIGP external call and sense running status order codes, SIGP external call and sense running status interpretation facilities are used, such that the actions of those order codes are performed absent hypervisor emulation and associated intervention.

The control program executing a signal processor instruction (e.g., the Signal Processor (SIGP) instruction) may be a guest within a virtualized environment. For instance, as depicted in FIG. 4A, a virtualized environment 400 includes a plurality of guest levels, including, for instance, guest level 0 (410), guest level 1 (420), guest level 2 (430) and a guest level 3 (440). Guest level 0 includes, for instance, a machine 412 having one or more hardware processors 414 (e.g., central processing units) and/or firmware 416. Firmware includes, e.g., the microcode or millicode of a processor. It includes, for instance, the hardware-level instructions and/or data structures used in implementation of higher-level machine code. In one embodiment, it includes, for instance, proprietary code that is typically delivered as microcode or millicode that includes trusted software, microcode or millicode specific to the underlying hardware and controls operating system access to the system hardware.

Guest level 1 (420) includes, for instance, a logical partition in which a hypervisor 422 executes and a virtual machine 424 in which a control program executes. Guest level 2 (430) includes, for instance, a hypervisor 432; and guest level 3 (440) includes, for instance, a virtual machine 442 in which a control program executes. Each of guest levels 1-3 may execute additional, fewer and/or other virtual machines, logical partitions, hypervisors, control programs, etc. Further, there may be additional, fewer and/or other guest levels. Many examples are possible.

In one example, each of guest levels 1-3 has one or more virtual processors (e.g., virtual central processing units) assigned thereto. A virtual processor represents at least a portion of a physical central processing unit of hardware processors 414.

In one example architecture (e.g., the z/Architecture instruction set architecture), the first two levels of virtualization (e.g., guest level 1 and guest level 2) are hardware-assisted levels of virtualization. The hardware assists provide a significant increase in guest execution speed, since the hypervisor does not need to emulate every instruction. Additional levels of virtualization are allowed (e.g., guest level 3); however, these additional levels of virtualization are not hardware-assisted, in one example, and are referred to as nested or virtualized.

In one example, the dispatch of a guest processor (e.g., a guest or virtual central processing unit; also referred to herein as a guest) on a physical processor is performed using, for instance, a start interpretative instruction (e.g., a Start Interpretive Execution (SIE) instruction). The hypervisor executing the Start Interpretative Execution instruction is referred to, in one example, as the host. Execution of the Start Interpretive Execution instruction places the processor (e.g., CPU) in interpretive-execution mode (SIE). In interpretive-execution mode, the processor performs selected functions of the interpreted machine, called the guest. Information pertinent to the state of the guest is located in a control structure (e.g., a control block), an example of which is referred to as a state description. A starting location of the state description is designated by the second operand address (e.g., value in register B₂ of the instruction concatenated with the value in D₂) of the instruction. The state description (an operand of the Start Interpretive Execution instruction) is used to define a guest processor's state (e.g., register values, controls, etc.; additional, fewer and/or other state may be included in the state description). Further, the control structure may be other than a state description, but still may include selected state information of the guest processor, and/or other information. Many examples are possible.

As indicated, in one or more examples, there may be several layers of virtualization. When a virtual processor (e.g., virtual central processing unit (vCPU)) on a second guest level (e.g., guest level 2 (430)) executes a Start Interpretative Execution instruction to dispatch a guest on a third guest level (e.g., guest level 3 (440)), the guest level 3 guest is referred to as a nested guest (e.g., nested guest 3), and further, is referred to as a nested virtual SIE (VSIE) guest, such as a nested VSIE guest 3.

To provide selected hardware-assisted virtualization to a nested virtual SIE guest, such as guest 3, nested virtual SIE guests are run as, e.g., a guest level 2 guest (also referred to herein as guest 2), as depicted in FIG. 4B (e.g., guest 442a). In this scenario, the state description that the guest 2 hypervisor creates to start guest 3 (the guest 3 state), referred to as the original state description, is partially copied into the guest level 1 guest (also referred to as guest 1 space). Guest 1 creates a guest 2 shadow state description representing guest 3 and combines the original guest 3's state with this state to generate a shadow guest state or a shadow guest state description. This shadow guest state description is then dispatched onto the physical processor by guest 1 as a guest level 2 guest (e.g., guest 442a).

Each guest processor's state is stored in a state description in memory (or another control structure). While the guest processor (e.g., virtual guest central processing unit) is running, the machine (e.g., machine 412) monitors changes to one or more selected fields of the state description. The machine includes hardware (e.g., physical processor(s) 414, physical processor components, etc.) and/or firmware 416.

One field of the state description monitored by the machine is a request field that includes an indicator (e.g., X bit) to indicate whether an external call is to be interpreted. For example, if the target processor's external call request field bit (X) in the target processor's state description is set to, e.g., 1, then the SIE firmware on the target processor attempts to interpret the external call (e.g., attempts to inject an external interrupt into the target processor).

The request field external call indicator (e.g., bit X) is set to, e.g., 1 by the sender processor's SIGP processing firmware (if in SIE) or by the hypervisor should the hypervisor wish to inject the interrupt, as examples. For a sender processor to set the target processor's request field external call indicator (e.g., bit X), the sender processor (e.g., sender central processing unit, sender virtual central processing unit) is to have the address of the target processor's state description.

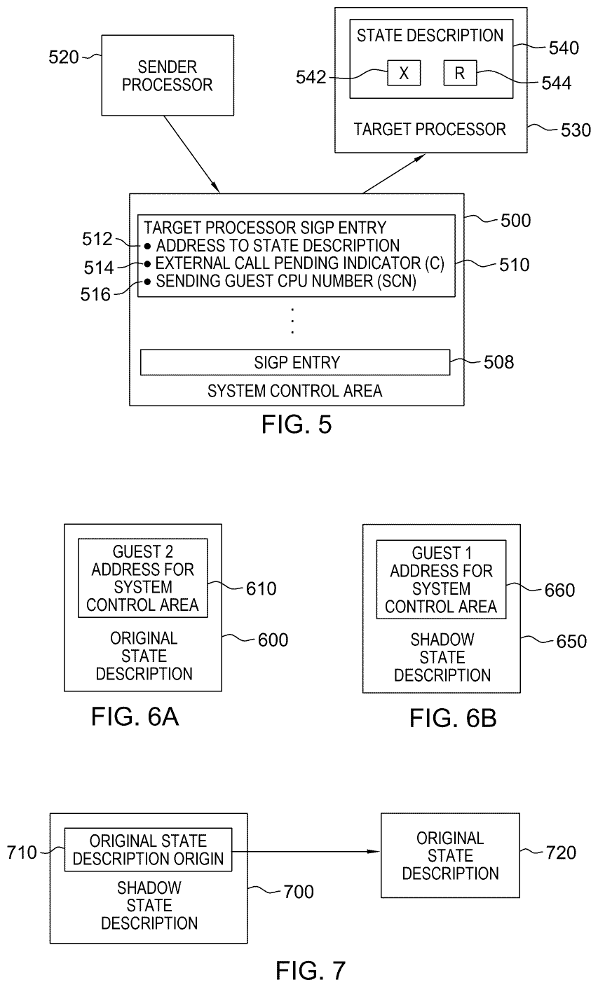

In one example, for guest 2 level guests (as well as other guest levels), the address of the target processor's state description is located in a system control area (or other control structure), which includes an entry (such as a signal processor (SIGP) entry) for each processor in the configuration. For instance, referring to FIG. 5, a system control area 500 includes at least one entry (e.g., SIGP entry) for each processor (e.g., virtual central processing unit) of the second guest level, including an entry (e.g., SIGP entry 508) for a sending or sender processor 520 and an entry (e.g., SIGP entry 510) for a target processor 530 (also referred to as a receiving or receiver processor), as well as entries for other processors, if part of the configuration.

An entry of system control area 500, such as SIGP entry 510, includes, for instance, an address 512 of a state description 540 of the target processor (e.g., target processor 530), and may include additional and/or other information. For instance, SIGP entry 510 includes, in one example: an external call pending indicator (C) 514, which when set to, e.g., one, indicates that an external call interruption is pending and is set to, e.g., zero when a corresponding external interruption is taken on the target processor; and a sending guest CPU number (SCN) 516, which is a virtual CPU number (VCN) of the sending guest CPU (e.g., sender processor 520) of a SIGP external call order from which an external call interruption is pending (e.g., C is set to one). This is, e.g., the VCN from the sender's state description. A SIGP entry may include additional, less and/or other information. Many examples are possible.

To access a SIGP entry for a target processor 530 (e.g., virtual central processing unit), a sender processor 520 uses a target processor's number (e.g., virtual CPU number (VCN)) to index into a system control area (e.g., system control area 500) to obtain a SIGP entry (e.g., SIGP entry 510) corresponding to the target processor (e.g., target processor 530). The SIGP entry is then used to obtain information and/or access the state description of the target processor. In one example, the SIGP entry (e.g., SIGP entry 510) is accessed by the sender processor (e.g., sender processor 520) to obtain an address 512 of a state description (e.g., state description 540) of the target processor (e.g., target processor 530) to set the target processor's request field external call indicator (e.g., bit X 542), as described herein.

Similarly, in one example, state description 540 also includes sense running status (R) 544, which tells sender processor 520 whether target processor 530 is currently running. In one example, the hypervisor sets and clears sense running status 544 (e.g., bit) depending on whether the processor (e.g., target processor 530) is scheduled to run or is running. Sense running status 544 is read by, e.g., the firmware of sender processor 520 and reported to the SIGP sender (e.g., sender processor 520). For instance, sender processor 520 uses the target processor's number (e.g., VCN) to index into the system control area (e.g., system control area 500) to retrieve the target processor's state description address (e.g., address 512) from system control area 500. For this, the system control area is to be contiguous within guest 1 memory. A Sender processor (e.g., sender processor 520) uses the address (e.g., address 512) to locate the state description (e.g., state description 540) of the target processor (e.g., target processor 530) to retrieve the sense running status (e.g., sense running status 544). This processing is performed in firmware without leaving guest mode, in one example.

As indicated herein, a guest level 3 virtual machine is dispatched via a guest 1 created shadow state description which merges the data of the original guest 3 state description (used by guest 2 to start guest 3) with the guest 2 state that guest 1 observes. Thus, there are multiple (e.g., 2) state descriptions for guest 3. For instance, as depicted in FIG. 6A, there is an original state description 600 that includes a guest 2 address (e.g., real or absolute) 610 for the system control area used to locate a SIGP entry for a processor (e.g., guest 3) and is known to guest 2 since it is the state description used by guest 2 to start guest 3; and referring to FIG. 6B, there is a shadow state description 650 that includes a guest 1 address (e.g., real or absolute) 660 for the system control area used to locate a shadow SIGP entry (described herein) for the processor (e.g., guest 3), which is the one actually being run by the guest 1 hypervisor for the guest 2 hypervisor. To keep them in synchronization, guest 1 copies data between them; however, the data is not copied continuously, and some data may be stale. There is also a cost in performance for the copying.

In one example, guest 2 is not able to access the shadow state description, and thus, any intervention requests by guest 2 (e.g., stop guest 3, etc.) is to be made to the original state description which delays the request until guest 1 reads the shadow state description and subsequently copies by the machine the original state description to the shadow state description.

In one example, the machine (e.g., firmware) knows about the shadow state description being used to run guest 3 but not the original state description since that resides in guest 2 storage whose context is not known by the machine when running a VSIE guest. Thus, to provide SIGP interpretation (e.g., access the system control area and obtain the external call indicator (e.g., bit X) or the sense running status (e.g., bit R), the machine is to know the guest 1 addresses (e.g., real or absolute) of both the shadow state description and the original state description. In one example, both the shadow and original state description addresses are to be provided to the machine for, e.g., virtual start interpretative execution (VSIE) signal processor (SIGP) interpretation (and/or other machine interpretation). This enables the machine to monitor request indicators at both locations (e.g., shadow and original) for low latency interrupt injection, allows the machine to read the running indicator from the original state description to avoid potentially reading a stale copy provided by guest 1, and allows the machine to access the target's original state description when, e.g., executing SIE and SIGP on a sender shadow state description.

To be able to monitor and access the original state description, in accordance with one or more aspects of the present disclosure, the shadow state description includes a field referred to as an original state description origin (OSDO) field. As depicted in FIG. 7, in one example, a shadow state description 700 of a processor (e.g., a guest level 3 virtual processor) includes a field 710, referred to as an original state description origin field, that points to an original state description 720 for that processor. In one example, the original state description origin is provided (e.g., set) by, e.g., guest 1 as, e.g., a guest 1 real or absolute address since guest 3 was dispatched on the physical processor via the shadow state description in guest 1. Since the original state description origin is provided by guest 1, the original state description origin is easily accessible by SIE and SIGP firmware. When the shadow state description is dispatched, the machine can setup monitors on both addresses.

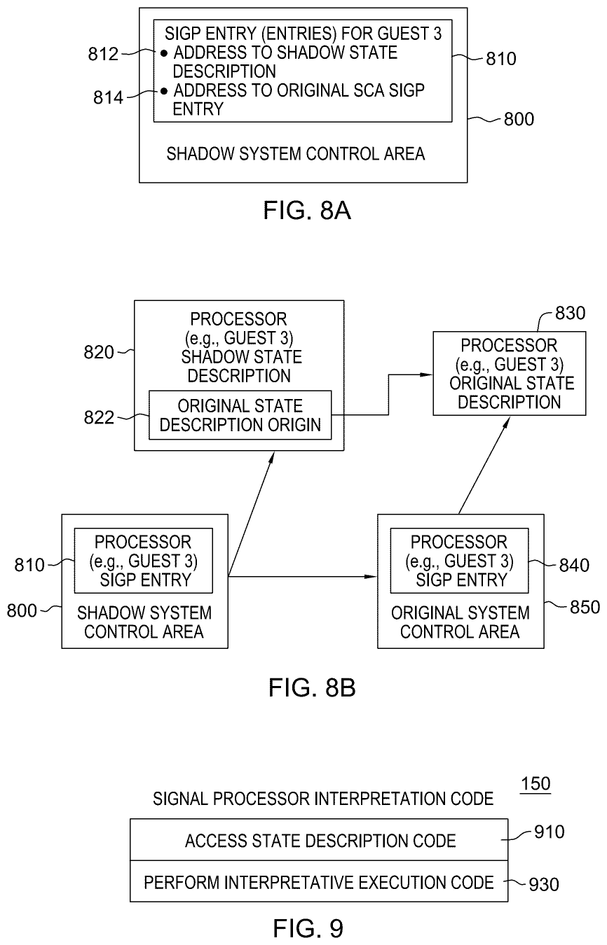

In accordance with one or more aspects, to facilitate providing the shadow state description (e.g., for the SIGP target) to the machine for, e.g., SIGP interpretation, a shadow system control area is provided. For instance, as depicted in FIG. 8A, a shadow system control area 800 is provided that includes one or more entries 810 (e.g., SIGP entries) for a virtual processor (e.g., guest 3 processor). The one or more entries include, for instance, an address 812 to the shadow state description for that processor (e.g., guest 3) and an address 814 to the original system control area SIGP entry of that processor. In one example, one entry in the shadow state control area indexed by the processor's number (e.g., guest 3 processor's VCN) includes both addresses. In another example, there are two entries for the processor: one that includes the address for the shadow state description (also referred to herein as a shadow state description address) and one that includes the address to the original system control area SIGP entry (also referred to herein as an original signal processor entry address). Other examples are possible.

Further details relating to using the shadow system control area (e.g., shadow system control area 800) are described with reference to FIG. 8B. In one example, shadow system control area 800 includes at least one SIGP entry 810 for guest 3 and that entry has an address pointing to guest 3's shadow state description 820 that includes, in one example, an original state description origin 822 pointing to guest 3's original state description 830.

Further, in one example, the at least one SIGP entry 810 in the shadow system control area may also include the address of the guest 3's original state description 830. The (original) state description address in the SIGP entry of the original system control area is, e.g., a guest 2 real address and, in one example, is not usable by the machine in a VSIE environment. However, the original state description address contained in the shadow state description and, in some examples, in the SIGP entry of the shadow system control area is, e.g., a guest 1 real address which is usable by the machine when running a VSIE guest.

Further, in one example, the at least one SIGP entry 810 in the shadow system control area also includes an address to a corresponding SIGP entry 840 in an original system control area 850 for guest 3, which has an address (e.g., guest 1 real address) to original state description 830. In one example, original system control area 850 is contiguous in guest 2 storage but not necessarily contiguous in guest 1 storage. In one example, the shadow system control area is addressed using, e.g., a guest 1 real or absolute address and is contiguous within guest 1 memory. This difference is resolved by providing, for instance, independent guest 1 original SIGP entry addresses for each virtual guest CPU number (VCN).

The original system control area SIGP entry (e.g., SIGP entry 840) includes, in one or more examples, certain information that may be used in VSIE, including, for instance, the external call pending indicator (C) and the sending guest CPU number (SCN), which are also in, the SIGP entry of the shadow system control area (e.g., SIGP entry 810), in one example, but inaccessible to level 2 guests. Thus, the shadow system control area is used, for instance, to locate the original system control area SIGP entry to obtain the external call pending indicator and the sending guest CPU number. Other examples are possible.

In one or more aspects, signal processor interpretation processing may use signal processor interpretation code (e.g., signal processor interpretation code 150). The code is, e.g., computer-readable program code (e.g., instructions) in computer-readable storage media, e.g., storage (persistent storage 113, cache 121, storage 124, other storage, as examples). The computer-readable storage media may be part of one or more computer program products and the computer-readable program code may be executed by and/or using one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute the code and/or portions thereof. Many examples are possible.

In one example, referring to FIG. 9, signal processor interpretation code 150 includes, for instance, access state description code 910 to be used to access one or more state descriptions of a virtual guest processor; and perform interpretative execution code 930 to be used to perform interpretative execution of one or more actions. Additional, less and/or other code may be used.

Although the signal processor interpretation code 150 is depicted in persistent storage 113, one or more code portions may be in other locations, other than persistent storage 113. Further, the code or portions of the code may be software, firmware and/or hardware. Many examples are possible.

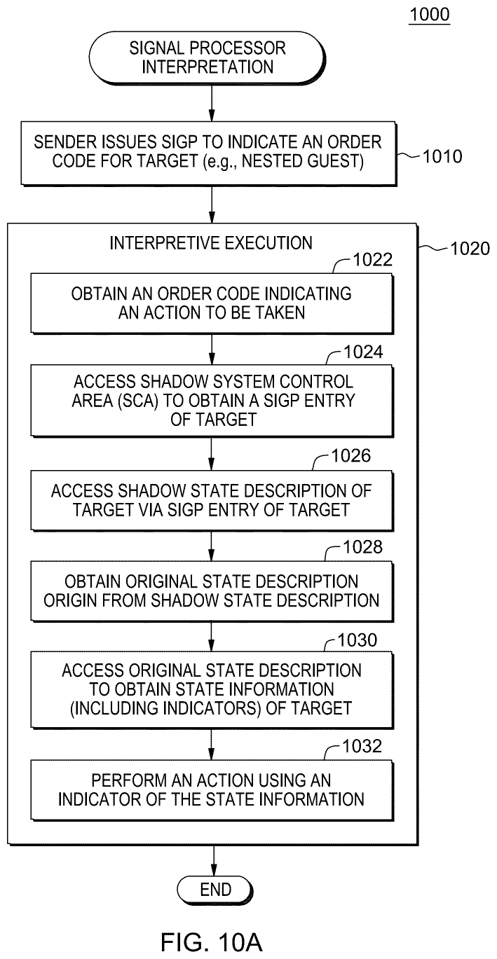

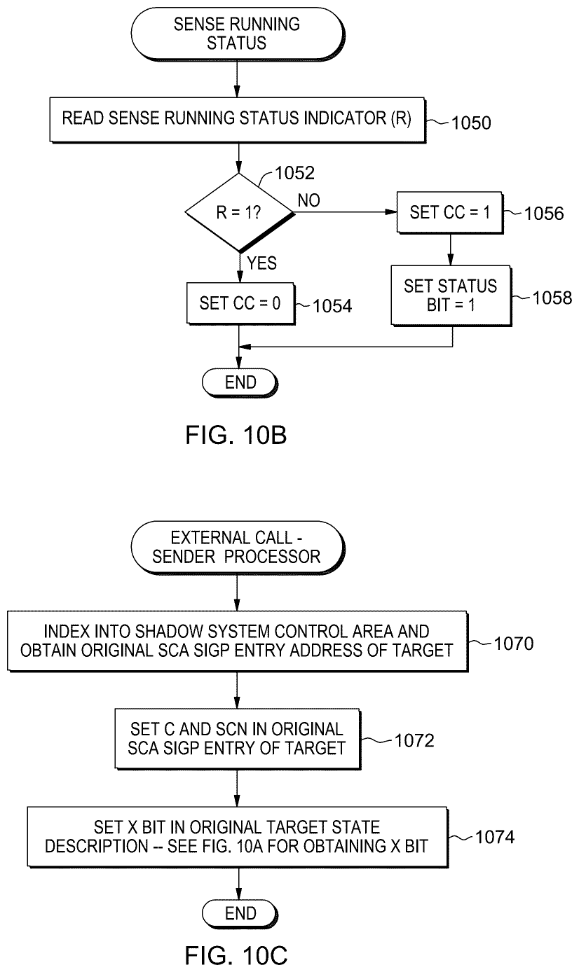

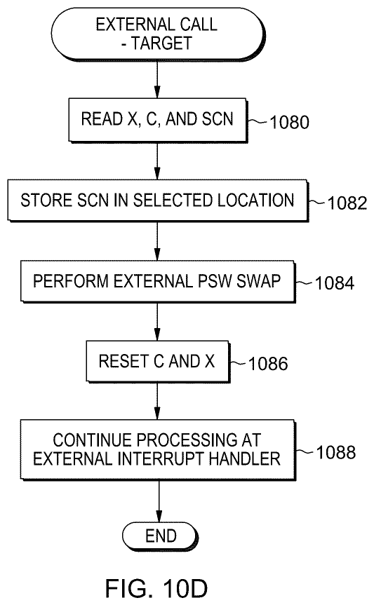

In one example, signal processor interpretation code 150 may be used in signal processor interpretation processing. One example of a signal processor interpretation process is described with reference to FIG. 10A. In one example, a signal processor interpretation process 1000 is executed by one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute the processing and/or aspects thereof. Many examples are possible.

In one example, a signal processor interpretation process 1000 (also referred to as process 1000) includes a sender (e.g., processor, virtual processor, virtual central processing unit) issuing 1010 a signal processor instruction (e.g., a Signal Processor (SIGP) instruction) to indicate an order code to be interpretatively executed for a target (e.g., a processor, virtual processor, virtual central processing unit). In one example, the sender and the target are nested guests (e.g., guest level 3). For instance, each was started by a Start Interpretative Execution (SIE) instruction issued by a guest level 2 processor.

The SIGP instruction executed by the sender provides an order code for the target processor. For instance, the SIGP instruction may transmit the order code to the target, such that the target takes action (optionally, in addition the sender). For instance, for an external call order code, action is taken by both the sender and the target (e.g., firmware of the machine executing the sender virtual processor and firmware of the machine executing the target virtual processor). As another example, the SIGP instruction indicates, based on the order code, an action to be taken for the target (e.g., obtain sense running status of the target). Other examples are possible.

Based on the sender executing the SIGP instruction, the machine (e.g., one or more hardware or physical processors 414 and/or firmware 416 of machine 412) performs 1020 interpretative execution based on the order code (e.g., using perform interpretative execution code 910). As an example, the machine obtains 1022 an order code indicating an action to be taken. The order code is included in the SIGP instruction being executed. The machine accesses 1024 a shadow system control area (SCA) to obtain a SIGP entry of the target. The machine uses the SIGP entry of the target to access 1026 a shadow state description of the target. The machine obtains 1028 an original state description origin from the shadow state description. The original state description origin points to an original state description for the target processor. The original state description includes, for instance, a sense running status (R) indicator and an external call interruption pending (X) indicator. The machine accesses 1030 the original state description (e.g., using access state description code) to obtain and potentially update state information of the target. The state information includes one or more of the sense running status indicator (R) and the external call interruption pending indicator (X).

The machine performs 1032 an action using an indicator from the state information obtained from the original state description, based on the order code. Examples of performing actions, as part of interpretive execution, are described with reference to FIGS. 10B-10D.

One example action is obtaining sense running state using the sense running state indicator (R) of the original state description, as described with reference to FIG. 10B.

Referring to FIG. 10B, if the order code of the SIGP instruction indicates sense running status, then, in one example, the machine reads 1050 the sense running status indicator (R) in the original state description of the target (e.g., virtual processor). The machine determines 1052 whether a value of the sense running status is set to a selected value, e.g., one, indicating that the target is running. If the sense running status indicator indicates that the target is running, then the machine sets 1054 a condition code (cc) to a selected value, e.g., zero, and sense running status interpretation ends. However, if the indicator indicates that the target is not running, then the machine sets 1056 the condition code to another selected value, e.g., one and sets 1058 a status bit (e.g., status bit 53) to a chosen value, e.g., one. This completes sense running status interpretation.

Another example of an action to be performed using an indicator of the original state description is an external call that uses the external call interruption pending indicator (X) of the original state description. Further details of performing this action are described with reference to FIGS. 10C-10D. In this example, using the X indicator is one aspect of interpretatively executing the external call; other aspects are also described with reference to FIGS. 10C-10D. The processing of FIG. 10C is one example of actions to be taken by the sender (e.g., the firmware of the sender processor) in interpretively executing an external call order code, and FIG. 10D depicts one example of actions to be taken by the target (e.g., the firmware of the target processor) in interpretively executing an external call order code.

Referring to FIG. 10C, if the order code of the SIGP instruction indicates an external call, then in one example, the sender (e.g., machine, such as hardware and/or firmware executing the sender virtual processor) indexes 1070 into the shadow system control area (e.g., using the targets VCN) to locate a SIGP entry for the target (e.g., entry 810). From the SIGP entry in the shadow system control area, the sender obtains an original SCA SIGP entry address of an original SCA SIGP entry of the target. In the original SCA SIGP entry of the target, the sender sets 1072 the external call pending indicator (C) and the sender CPU number (SCN) fields. Further, the sender sets 1074 the X indicator in the original target state description (see FIG. 10A for obtaining the X bit). This concludes SIGP processing on the sender and a next instruction may be processed.

In one example, based on setting the X indicator, the machine interrupt routine takes over processing. For instance, based on the machine monitoring the X indicator or based on polling of the X indicator, the interrupt routine of the machine (e.g., firmware) executing the target virtual processor is given control and processing is performed, as described with reference to FIG. 10D.

Referring to FIG. 10D, in one example, the target (e.g., the machine interrupt routine) reads 1080 multiple indicators/fields, including the X indicator from the original state description and the C and SCN fields from the original SCA SIGP entry. It stores 1082 the SCN in a selected memory location and performs 1084 an external program status word (PSW) swap. Further, in one example, the target processor (e.g., firmware) resets 1086 the external call pending indicator (C) and the external call interruption pending indicator (X) and the control program continues processing 1088 at the guest external interrupt (IRQ) handler.

Described above is a capability for providing hardware-assisted (e.g., hardware/firmware) interpretative execution for guests that previously were unable to benefit from hardware-assisted interpretative execution. As described herein, previously selected computer hardware/firmware were configured to provide accelerated support for two levels of running guests. The first level guest may be a hypervisor, referred to as guest 1, which may dispatch a second level guest, such as a control program (e.g., operating system), referred to as guest 2. Running code inside of a guest level 1 or 2 is performed using, for instance, a Start Interpretative Execution instruction whose operand defines the guest CPU state and is called a state description, in one example.

If additional levels of virtualization were to be used, then previously software provided it using a technique that is sometimes referred to as virtual SIE (or VSIE) for certain processors and is often called nesting. Nesting is commonly used when debugging a hypervisor, running virtual machine containers inside guests and emulating hypervisor features, as examples.

This VSIE virtualization is accomplished by combining the guest 2 and guest 3 states into a filtered shadow state, which can then be dispatched by the guest 1 hypervisor as a guest 2 on the hardware. Thus, shadow copies of, for example, the guest 3 state description is used, as well as combined guest 2 and guest 3 address translation tables.

Within a given guest configuration when a sender processor wishes to request that a specific operation be done by a receiving or target processor, the sender signals the receiver. Such signals are called inter-processor interrupts and, in one example, this signaling is done using, for instance, a Signal Processor instruction. These signals are used by control programs (e.g., operating systems) to keep latency low.

In one example, hardware assist is provided that uses a location in the guest state description where certain pending SIGP requests are maintained. This location is monitored by the machine (e.g., hardware and firmware) to be able to interpret those requests in hardware for both the sender and the receiver (or target) without costly hypervisor intervention. This approach allows the hypervisor to signal the guest CPU using these same pending bits in storage and have the machine interpret that action in the receiver.

For guest 2, this interpretation is provided using a system control area. The system control area contains a header which holds information about the configuration such as which processors are configured. It also contains an entry for each virtual processor within that configuration which holds information about that processor such as the associated state description address.

In one example, the state description contains an address to the system control area origin. The system control area contains a header and then the SIGP entries. The original system control area origin address in the original state description is, e.g., a guest 2 real address. The system control area is contiguous in guest 2 space so a single origin address is used by the guest 2 hypervisor to determine, e.g., the guest 2 real address of each SIGP entry. When running VSIE, the machine is unable, in one example, to use the guest 2 real address because it does not have the context associated with that address. This means that a guest 1 address is to be used. Since the original system control area is not necessarily contiguous in guest 1 space, it is not as easy to use a single address to determine the SIGP entry offset from that. Therefore, in one example, a guest 1 shadow structure is provided which is contiguous in guest 1 storage to provide these independent pointers.

With virtual start interpretive execution (VSIE), there are multiple (e.g., two) state descriptions which both represent, e.g., a guest 3 vCPU: The shadow state description maintained by guest 1 and the original state description maintained by guest 2. Previously, the interpretation was unable to handle multiple state descriptions, and therefore, SIGP commands were not interpreted for a VSIE guest.

Therefore, in accordance with one or more aspects, SIGP interpretation is provided for a VSIE guest. In one or more aspects, a mechanism is provided that allows the machine to interpret certain SIGP operations for a VSIE guest. In one or more aspects, the machine is able to interpret both the sending and receiving side of these SIGP requests by VSIE guest processors (e.g., CPUs). Further, in one or more aspects, interpretation is provided for the hypervisor injecting a SIGP interrupt when the target vCPU is running.

In one example, the VSIE guest 2 original hypervisor state is not available to the machine since it does not have support to access the guest 2's memory where it is stored. There is a window condition if the hypervisor state is distributed between the original and shadow control structures. The machine, guest 2 and guest 1 can and will update hypervisor state independently, and thus, strict rules apply.

In one or more aspects, the machine is able to provide interpretation of certain guest 3 SIGP orders. To achieve this, in one example: the guest 2 and guest 1 hypervisors, as well as, the machine are to have the ability to determine if a SIGP interrupt is pending and are to have the ability to make one pending; the guest 2 hypervisor has access to the guest 2 address space but not to the guest 1 address space; the guest 2 state descriptions and system control areas' contents are to be honored for SIGP interpretation; and the VSIE guest 3 is dispatched on the machine by the guest 1 hypervisor. Therefore, when guest 3 is running, the machine does not have access to the guest 2 context. These SIGP requests are to be recognized in a timely fashion.

In one or more aspects, a single place is provided for the maintaining of the pending SIGP requests, the original state description and original system control area in guest 2 space. This reduces or eliminates the window that exists between the time when the guest 3 operating system is dispatched or not, as well as when the guest 2 hypervisor is dispatched or not. This also satisfies that the guest 2 state descriptions and system control areas' contents are to be honored for SIGP interpretation.

In one or more aspects, the machine is provided a way for the machine to access both the original and shadow hypervisor state without requiring to translate guest 2 addresses. This is accomplished by, for instance, adding a field which contains the guest 1 original state description and system control area address to the shadow state description and system control area, respectively, as well as an original state description address to the system control area CPU entry. As these addresses are guest 1 physical addresses, the machine is able to access the referenced memory areas.

In one or more aspects, the existing mechanism used by the guest 2 hypervisor is to remain unchanged. It still accesses its state description and system control area to perform SIGP emulation and inject certain interrupts. This means that any guest 2 hypervisor that worked on the machine without this feature will also be able to keep working if the feature is active. The feature is transparent to guest 2.

In one or more aspects, in the case of a VSIE environment in which secure execution is being used, SIGP interpretation is used since the hypervisor function related to the guest is very minimal for security reasons. Trusted firmware provides SIGP interpretation and can therefore be used securely. In one or more aspects, SIGP interpretation for a VSIE secure execution guest is allowed.

In one or more aspects, since a machine (e.g., firmware) has the addresses and monitors both state descriptions, the delay before handling a SIGP external call request is reduced; and SIGP external call and sense running status can be interpreted for VSIE guests; thus, eliminating hypervisor emulation for these tasks which improves performance for VSIE guests. Further, in one or more aspects, the interpretation allows secure execution guests to be run as VSIE guests since SIGP interpretation is to be used for secure execution for security reasons.

In one or more aspects, a structure is provided which allows the machine to access guest 2 storage without the guest 2 context. Monitoring of both the shadow and original state descriptions is provided, reducing or eliminating windows in which the shadow state description contains stale data. In one or more aspects, the original system control area (e.g., in guest 2) remains intact and accessible by the guest 2 while still providing a mechanism for the machine to monitor those updates.

In one or more aspects: an interrupt signal is sent from a sender processor to a receiving processor, in which the signaling is done using a signal processor instruction (SIGP); a start virtual interpretive execution (VSIE) instruction is used, in which operands of the instruction contain a guest CPU state description and information on further levels of virtualization; SIGP interpretation is provided for a VSIE guest; certain performance critical SIGP operations are interpreted for the VSIE guest—interpreting both the sending and receiving side of these SIGP signals/requests by VSIE guest CPU; and/or interpretation is added for the hypervisor injecting a SIGP interrupt when the target VCPU is running.

In one or more aspects: a determination is made by the computer environment that guest 2 and guest 1 hypervisors and the processors have the ability to determine if a SIGP interrupt is pending and the ability to make one SIGP interrupt pending; the guest 2 hypervisor has access to the guest 2 address space but not to the guest 1 address space; the guest 2 state descriptions and system control areas contents are honored for SIGP interpretation; a VSIE guest 3 is dispatched in the computing environment by the guest 1 hypervisor, in which the computing environment does not have access to guest 2 as long as guest 3 is running; and/or SIGP interrupts/signals/requests are recognized in a timely fashion.

Although machine interpretation for SIGP is described herein as an example, one or more aspects may be used for other machine interpretations. Many examples are possible.

Although various examples are described above, other variations and embodiments are possible. Further, other types of instructions may use one or more aspects of the present disclosure.

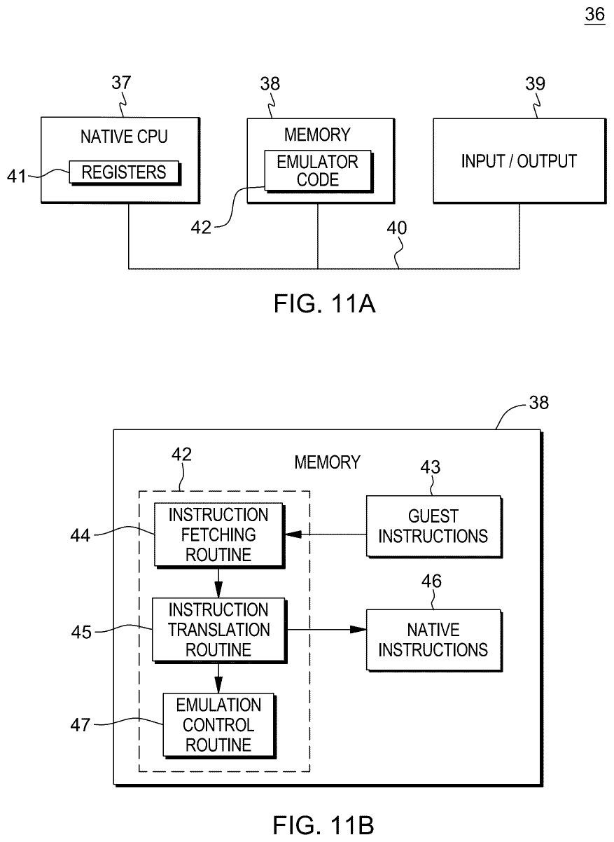

Further, although one or more examples of a computing environment to incorporate and use one or more aspects of the present disclosure are described herein, FIGS. 11A-11B depict another embodiment of a computing environment to incorporate and use one or more aspects of the present disclosure.

Referring, initially, to FIG. 11A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 11B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native CPU 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native CPU 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native CPU or by using locations in memory 38. In embodiments, guest instructions 43, native instructions 46 and emulator code 42 may reside in the same memory or may be disbursed among different memory devices.

An example instruction that may be emulated is the Start Interpretative Execution instruction and/or the Signal Processor instruction described herein, in accordance with one or more aspects of the present disclosure. Further, one or more aspects of the present disclosure may be emulated.

The computing environments described herein are only examples of computing environments that can be used. One or more aspects of the present disclosure may be used with many types of environments. The computing environments provided herein are only examples. Each computing environment is capable of being configured to include one or more aspects of the present disclosure. For instance, each may be configured to perform machine interpretation for a virtualized guest configuration, perform signal processor machine interpretation for a virtualized guest configuration and/or perform one or more other aspects of the present disclosure.

One or more aspects of the present disclosure are tied to computer technology and facilitate processing within a computer, improving performance thereof. For instance, processing speed is increased, and latency, as well as costs, are reduced. Processing within a processor, computer system and/or computing environment is improved.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet a further aspect, a process for integrating computing infrastructure comprising integrating computer-readable code into a computer system may be provided. The computer system comprises a computer-readable medium, in which the computer medium comprises one or more embodiments. The code in combination with the computer system is capable of performing one or more embodiments.

Although various embodiments are described above, these are only examples. For example, other instructions, instruction formats, operands and/or registers may be used. Moreover, additional, less and/or other code may be used. Although code may be provided as an example of performing a particular operation or task, additional and/or other code may be used. Code may be combined and are separated. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product comprising:
a set of one or more computer-readable storage media; and
program instructions, collectively stored in the set of one or more computer-readable storage media, for causing at least one computing device to perform computer operations including:
performing interpretative execution by a physical processor of a computing environment for a virtual processor executing on the physical processor, the performing interpretative execution including:
obtaining an order code indicating an action to be taken for the virtual processor;
accessing a shadow state description of the virtual processor to obtain an original state description origin, the original state description origin indicating a location of an original state description of the virtual processor, the original state description including state information of the virtual processor; and
performing an action using an indicator of the state information of the virtual processor, the indicator selected based on the order code, and wherein the action is performed by the physical processor on behalf of the virtual processor.

2. The computer program product of claim 1, wherein the accessing the shadow state description includes accessing a shadow signal processor entry of a shadow system control area to obtain a shadow state description address of the shadow state description.

3. The computer program product of claim 2, wherein the shadow signal processor entry further includes an original signal processor entry address of an original signal processor entry of an original system control area of the virtual processor.

4. The computer program product of claim 3, wherein the original signal processor entry and the shadow signal processor entry include information for the virtual processor, and wherein selected information is accessible from the original signal processor entry rather than the shadow signal processor entry.

5. The computer program product of claim 1, wherein the order code includes obtaining a sense running status of the virtual processor that specifies whether the virtual processor is running.

6. The computer program product of claim 1, wherein the order code includes an external call external interruption.

7. The computer program product of claim 1, wherein the virtual processor is a nested virtual processor.

8. The computer program product of claim 1, wherein the virtual processor is initiated via a start interpretative execution instruction, the start interpretative execution instruction including an operand that specifies a location of the original state description of the virtual processor.

9. The computer program product of claim 1, wherein the original state description of the virtual processor is accessible to the physical processor via the shadow state description and directly inaccessible to the physical processor.

10. The computer program product of claim 1, wherein the obtaining the order code includes obtaining the order code based on execution of a signal processor instruction by another virtual processor, the signal processor instruction specifying the order code and the virtual processor.

11. A computer system comprising:
at least one computing device;
a set of one or more computer-readable storage media; and
program instructions, collectively stored in the set of one or more computer-readable storage media, for causing the at least one computing device to perform computer operations including:
performing interpretative execution by a physical processor of a computing environment for a virtual processor executing on the physical processor, the performing interpretative execution including:
obtaining an order code indicating an action to be taken for the virtual processor;
accessing a shadow state description of the virtual processor to obtain an original state description origin, the original state description origin indicating a location of an original state description of the virtual processor, the original state description including state information of the virtual processor; and
performing an action using an indicator of the state information of the virtual processor, the indicator selected based on the order code, and wherein the action is performed by the physical processor on behalf of the virtual processor.

12. The computer system of claim 11, wherein the accessing the shadow state description includes accessing a shadow signal processor entry of a shadow system control area to obtain a shadow state description address of the shadow state description, and wherein the shadow signal processor entry further includes an original signal processor entry address of an original signal processor entry of an original system control area of the virtual processor.

13. The computer system of claim 12, wherein the original signal processor entry and the shadow signal processor entry include information for the virtual processor, and wherein selected information is accessible from the original signal processor entry rather than the shadow signal processor entry.

14. The computer system of claim 11, wherein the order code includes obtaining a sense running status of the virtual processor that specifies whether the virtual processor is running.

15. The computer system of claim 11, wherein the order code includes an external call external interruption.

16. The computer system of claim 11, wherein the virtual processor is a nested virtual processor.

17. A computer-implemented method comprising:
performing interpretative execution by a physical processor of a computing environment for a virtual processor executing on the physical processor, the performing interpretative execution including:
obtaining an order code indicating an action to be taken for the virtual processor;
accessing a shadow state description of the virtual processor to obtain an original state description origin, the original state description origin indicating a location of an original state description of the virtual processor, the original state description including state information of the virtual processor; and
performing an action using an indicator of the state information of the virtual processor, the indicator selected based on the order code, and wherein the action is performed by the physical processor on behalf of the virtual processor.

18. The computer-implemented method of claim 17, wherein the accessing the shadow state description includes accessing a shadow signal processor entry of a shadow system control area to obtain a shadow state description address of the shadow state description, and wherein the shadow signal processor entry further includes an original signal processor entry address of an original signal processor entry of an original system control area of the virtual processor.

19. The computer-implemented method of claim 18, wherein the original signal processor entry and the shadow signal processor entry include information for the virtual processor, and wherein selected information is accessible from the original signal processor entry rather than the shadow signal processor entry.

20. The computer-implemented method of claim 17, wherein the order code includes obtaining a sense running status of the virtual processor that specifies whether the virtual processor is running.

21. The computer-implemented method of claim 17, wherein the order code includes an external call external interruption.

22. The computer-implemented method of claim 17, wherein the virtual processor is a nested virtual processor.

23. A computer program product comprising:
a set of one or more computer-readable storage media; and
program instructions, collectively stored in the set of one or more computer-readable storage media, for causing at least one computing device to perform computer operations including:
performing interpretative execution by a physical processor of a computing environment for a virtual processor executing on the physical processor, the performing interpretative execution including:
accessing a shadow control structure of the virtual processor to obtain addressability to an original control structure of the virtual processor, the original control structure including state information of the virtual processor; and
performing an action using the state information of the virtual processor, wherein the action is performed by the physical processor on behalf of the virtual processor.

24. The computer program product of claim 23, wherein the shadow control structure is a control structure selected from set of control structures, the set of control structures including a shadow state description of the virtual processor and a shadow system control area of the virtual processor, and wherein the original control structure is another control structure selected from another set of control structures, the another set of control structures including an original state description of the virtual processor and an original system control area of the virtual processor.

25. A computer-implemented method comprising:
performing interpretative execution by a physical processor of a computing environment for a virtual processor executing on the physical processor, the performing interpretative execution including:
accessing a shadow control structure of the virtual processor to obtain addressability to an original control structure of the virtual processor, the original control structure including state information of the virtual processor; and
performing an action using the state information of the virtual processor, wherein the action is performed by the physical processor on behalf of the virtual processor.
